(19) United States
(12) Patent Application Publication
(10) Pub. No.: US 2026/0188574 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Seung Yeon LEE, Suwon-si, (KR); Seo Ho LEE, Suwon-si (KR); Berm Ha CHA, Suwon-si (KR)

(73) Assignee: SAMSUNG ELECTRO-MECHANICS CO., LTD., Suwon-si (KR)

(21) Appl. No.: 19/371,187

(22) Filed: Oct. 28, 2025

(30) Foreign Application Priority Data
Dec. 30, 2024 (KR) 10-2024-0200312

(51) Int. Cl. H01G 2/14; H01G 4/005; H01G 4/30

(52) U.S. Cl. CPC H01G 2/14; H01G 4/005; H01G 4/30

(57) ABSTRACT

A multilayer electronic component includes: a body including a dielectric layer and an internal electrode layer and a floating electrode layer alternately disposed in a first direction with the dielectric layer interposed therebetween; a first external electrode; and a second external electrode, and the internal electrode layer may include a first electrode pattern connected to the first external electrode, and a second electrode pattern connected to the second external electrode spaced apart from the first electrode pattern, and a first heat dissipation pattern disposed between the first electrode pattern and the second electrode pattern, and the floating electrode layer may include a floating electrode pattern, and a second heat dissipation pattern spaced apart from the floating electrode pattern.

### CROSS-REFERENCE TO RELATED APPLICATION(S)

This application claims benefit of priority to Korean Patent Application No. 10-2024-0200312 filed on Dec. 30, 2024, in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-shaped capacitor mounted on the printed circuit boards of various types of electronic products such as video devices such as Liquid Crystal Displays (LCD) and Plasma Display Panel (PDP), computers, smartphones and mobile phones, and the circuits of the onboard charger (OBC) DC-DC converter of electric vehicles, and the like, and playing a role in charging or discharging electricity.

As electric vehicles (EV), autonomous driving, and high-performance infotainment systems expand, demand for multilayer ceramic capacitors with high reliability, high capacity, and high voltage characteristics increases.

Specifically, divided internal electrodes and floating electrodes are applied to form a plurality of capacitor components and to form a structure in which each capacitor component is connected in series, so that the stability of multilayer ceramic capacitors under high voltage is sought.

However, a structure including these divided internal electrodes and floating electrodes may cause the problem of increased heat generation due to the effect of equivalent series resistance (ESR), and may cause the problem of not being able to effectively dissipate the generated heat as a ratio of electrodes drawn out to the outside of the device decreases.

Meanwhile, when applying a design in which internal electrodes are formed thickly for the purpose of improving the heat generation problem, a step portion occurs in a non-overlapping area of the internal electrodes and floating electrodes in a stacking direction, and the step portion may cause warpage of the floating electrode and may be a main cause of cracking defects in a multilayer ceramic capacitor.

Accordingly, in a multilayer ceramic capacitor to which divided internal electrodes and floating electrodes, structural improvement is required to improve heat dissipation characteristics and prevent warpage of the floating electrode.

### SUMMARY

An aspect of the present disclosure is to improve the problem of deterioration of heat dissipation characteristics of a multilayer electronic component having a structure including divided internal electrodes and floating electrodes.

An aspect of the present disclosure is to improve the problem of warpage of a floating electrode in a multilayer electronic component having a structure including divided internal electrodes and floating electrodes.

However, the aspects of the present disclosure are not limited to the above-described contents, and may be more easily understood in the process of describing specific example embodiments of the present disclosure.

A multilayer electronic component according to an example embodiment of the present disclosure may include: a body including a dielectric layer and an internal electrode layer and a floating electrode layer alternately disposed in a first direction with the dielectric layer interposed therebetween, and including a first surface and a second surface opposing each other in the first direction, a third surface and a fourth surface opposing each other in a second direction, perpendicular to the first direction, and a fifth surface and a sixth surface opposing each other in a third direction, perpendicular to the first direction and the second direction; a first external electrode disposed on the third surface; and a second external electrode disposed on the fourth surface, and the internal electrode layer may include a first electrode pattern connected to the first external electrode at the third surface, and a second electrode pattern connected to the second external electrode on the fourth surface and spaced apart from the first electrode pattern in a second direction, and a first heat dissipation pattern disposed between the first electrode pattern and the second electrode pattern, and the floating electrode layer may include a floating electrode pattern spaced apart from the third surface to the sixth surface, and a second heat dissipation pattern spaced apart from the floating electrode pattern in the third direction.

One effect of the present disclosure is to, in a multilayer electronic component including an internal electrode layer including divided electrode patterns and a floating electrode layer including a floating electrode, improve heat dissipation characteristics of a multilayer electronic component and to prevent warpage of a floating electrode by disposing a heat dissipation pattern between electrode patterns and by disposing a heat dissipation pattern in a region in which a floating electrode pattern is not disposed.

However, the various advantageous advantages and effects of the present disclosure are not limited to the above-described contents, and may be more easily understood in the process of explaining specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a cross-sectional view taken along line I-I′ of FIG. 1;

FIG. 3 is a cross-sectional view taken along line II-II′ of FIG. 1;

FIG. 4 is a cross-sectional view taken along line III-III′ of FIG. 1;

FIG. 5 is a plan view illustrating an internal electrode layer according to an example embodiment; and

FIG. 6 is a plan view illustrating a floating electrode layer according to an example embodiment.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to more completely explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In the drawing, a first direction may be defined as a stacking direction or a thickness direction (X-direction), a second direction may be defined as a length direction (Y-direction), and a third direction may be defined as a width direction (Z-direction).

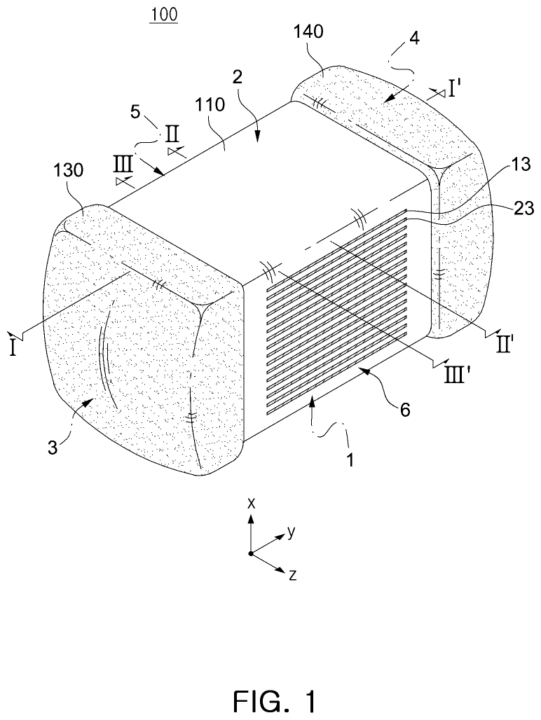

FIG. 1 is a schematic perspective view of a multilayer electronic component according to an example embodiment of the present disclosure.

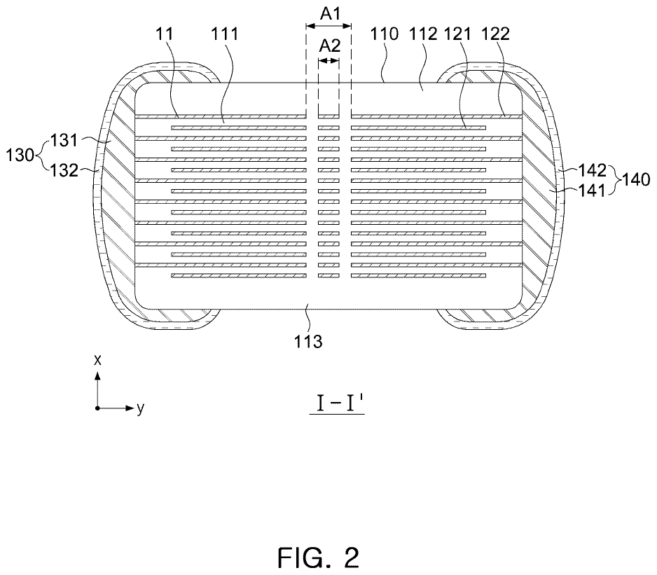

FIG. 2 is a cross-sectional view taken along line I-I′ of FIG. 1.

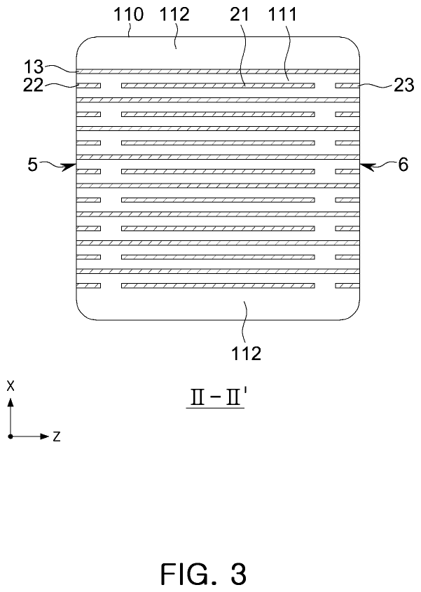

FIG. 3 is a cross-sectional view taken along line II-II′ of FIG. 1.

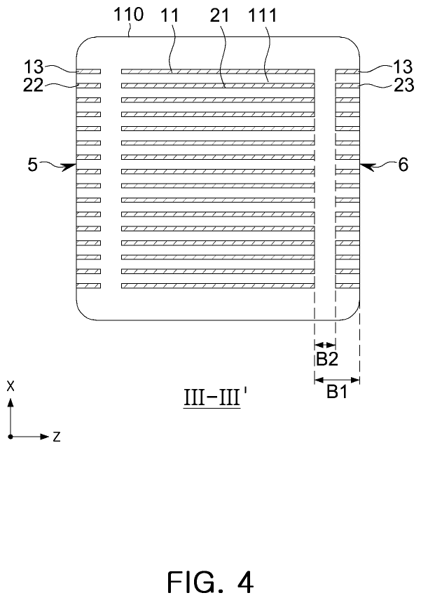

FIG. 4 is a cross-sectional view taken along line III-III′ of FIG. 1.

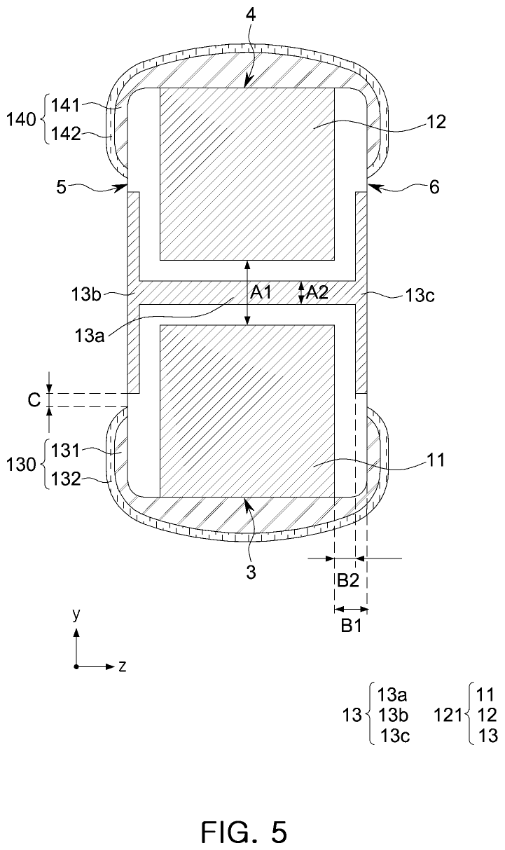

FIG. 5 is a plan view illustrating an internal electrode layer according to an example embodiment.

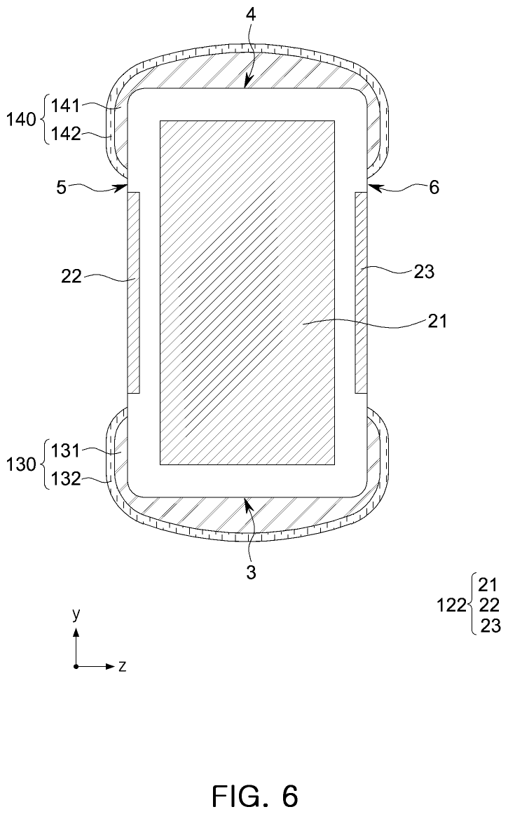

FIG. 6 is a plan view illustrating a floating electrode layer according to an example embodiment.

Hereinafter, a multilayer electronic component 100 according to an example embodiment of the present disclosure and various example embodiments thereof will be described in detail with reference to FIGS. 1 to 6. Additionally, a multilayer ceramic capacitor (hereinafter referred to as ‘MLCC’) will be described as an example of a multilayer electronic component, but the present disclosure is not limited thereto and may be applied to various multilayer electronic components using ceramic materials.

A multilayer electronic component 100 according to an example embodiment of the present disclosure may include a body 110 including a dielectric layer 111 and an internal electrode layer 121 and a floating electrode layer 122 alternately arranged in a first direction with the dielectric layer 111 interposed therebetween, and including a first surface 1 and a second surface 2 opposing each other in the first direction, a third surface 3 and a fourth surface 4 opposing each other in a second direction, perpendicular to the first direction, and a fifth surface 5 and a sixth surface 5 opposing each other in a third direction, perpendicular to the first and second directions; a first external electrode 130 disposed on the third surface 3; and a second external electrode 140 disposed on the fourth surface 4, and the internal electrode layer 121 may include a first electrode pattern 11 connected to the first external electrode 130 on the third surface 3, a second electrode pattern 12 connected to the second external electrode 140 on the fourth surface 4 and spaced apart from the first electrode pattern 11 in a second direction, and a first heat dissipation pattern 13 disposed between the first electrode pattern 11 and the second electrode pattern 12, and the floating electrode layer 122 may include a floating electrode pattern 21 spaced apart from the third surface to the sixth surfaces 3, 4, 5 and 6, and second heat dissipation patterns 22 and 23 spaced apart from the floating electrode pattern 21 in a third direction.

The body 110 may include a dielectric layer 111, an internal electrode layer 121 and a floating electrode layer 122 alternately disposed between the dielectric layers 111.

There is no particular limitation on the specific shape of the body 110, but as illustrated, the body 110 may be formed in a hexahedral shape or a similar shape. Due to the shrinkage of ceramic powder particles included in the body 110 during the sintering process, the body 110 may not have a hexahedral shape having a perfect straight line, but may have a substantially hexahedral shape.

The body 110 may include the first surface and the second surface 1 and 2 opposing each other in the first direction, the third surface and the fourth surface 3 and 4 opposing each other in the second direction, perpendicular to the first direction, and the fifth surface and the sixth surface 5 and 6 opposing each other in the third direction, perpendicular to the first and second directions.

The first to sixth surfaces 1, 2, 3, 4, 5 and 6 of the body 110 may be connected, and thus the body 110 may be substantially hexahedral in shape.

Meanwhile, since margin regions in which an electrode pattern is not disposed on the dielectric layer 111 overlap each other, a step portion may occur due to the thickness of the internal electrode layer 121, and accordingly, an corner connecting the first surface and the third to sixth surfaces and/or an corner connecting the second surface and the third to sixth surfaces may have a shape contracted toward a center of the first direction of the body 110 when viewed based on the first surface or the second surface. Alternatively, a corner connecting the first surface 1 and the third to sixth surfaces 3, 4, 5 and 6 and/or a corner connecting the second surface 2 and the third to sixth surfaces 3, 4, 5 and 6 due to the shrinkage behavior during the sintering process of the body may have a shape contracted toward the center of the first direction of the body 110 when viewed from the first surface or the second surface. Alternatively, in order to prevent chipping defects, and the like, the corner connecting the first surface and the third to sixth surfaces and/or the corner connecting the second surface and the third to sixth surfaces may have a round shape.

The dielectric layer 111 forming the body 110 may be formed in plural, and the plurality of dielectric layers 111 may be in a sintered state, and boundaries between adjacent dielectric layers 111 may be integrated so as to difficult to identify without using a scanning electron microscope (SEM). The number of dielectric layers 111 stacked does not need to be particularly limited, and may be determined in consideration of a size of the multilayer electronic component. For example, the body may be formed by stacking 400 or more dielectric layers.

The dielectric layer 111 may be formed by preparing a ceramic slurry including ceramic powder particles, an organic solvent and a binder, applying and drying the slurry on a carrier film to prepare a ceramic green sheet, and then sintering the ceramic green sheet. The ceramic powder particles are not particularly limited as long as they may obtain sufficient electrostatic capacity, but, for example, barium titanate-based (BaTiO₃) powder particles may be used as the ceramic powder particles. For a more specific example, the ceramic powder particles may be one or more of BaTiO₃, (Ba1-ₓCaₓ)TiO₃ (0<x<1), Ba(Ti1-_{y}Ca_{y})O3 (0<y<1), (Ba1-ₓCaₓ)(Ti1-_{y}Zr_{y})O₃ (0<x<1, 0<y<1), and Ba(Ti1-_{y}Zr_{y})O₃ (0<y<1).

An average thickness of the dielectric layer 111 is not particularly limited.

In the case of miniaturization and high capacity of the multilayer electronic component 100, the average thickness of the dielectric layer 111 may be 0.35 μm or less, and in order to improve reliability of the multilayer electronic component 100 under high temperature and high voltage, the average thickness of the dielectric layer 111 may be 5 μm or more.

The average thickness of the dielectric layer 111 may refer to an average thickness of one or more dielectric layers, among the plurality of dielectric layers.

For example, the average thickness of the dielectric layer 111 may be a value obtained by averaging the thicknesses measured at ¼, 2/4, and ¾ points in which the dielectric layer is divided into four parts in a length direction, based on one layer of the dielectric layer adjacent to a point at which a longitudinal center line and a thickness direction center line of the body meet, in an image obtained by scanning first and second direction cross-sections cut from a central portion of the body 110 in the third direction by a scanning electron microscope (SEM). When the measurement is expanded to upper two and lower two dielectric layers having equal intervals based on one layer of the dielectric layer adjacent to the point at which the longitudinal center line and the thickness direction center line of the body, an average thickness of the dielectric layer may be further generalized.

The internal electrode layer 121 and the floating electrode layer 122 may be alternately disposed between the dielectric layers 111 in the first direction.

Referring to FIG. 5, the internal electrode layer 121 may include a first electrode pattern 11 in contact with the third surface 3, and a second electrode pattern 12 in contact with the fourth surface 4 and spaced apart from the first electrode pattern 11) in the second direction.

The first electrode pattern 11 may be connected to the first external electrode 130 to be described below, and the second electrode pattern 12 may be connected to the second external electrode 140 to be described below. The first electrode pattern 11 and the second electrode pattern 12 may be spaced apart from each other in the second direction, and accordingly, the first electrode pattern 11 and the second electrode pattern 12 may be electrically separated from each other.

Meanwhile, the first electrode pattern 11 and the second electrode pattern 22 may be spaced apart from the fifth surface 5 and the sixth surface 6.

A material included in the first and second electrode patterns 11 and 12 is not particularly limited, and a material having excellent electrical conductivity may be used. For example, the first and second electrode patterns 11 and 12 may include one or more of nickel (Ni), copper (Cu), palladium (Pd), silver (Ag), gold (Au), platinum (Pt), tin (Sn), tungsten (W), titanium (Ti) and alloys thereof.

The first and second electrode patterns 11 and 22 may be formed by printing a conductive paste on a ceramic green sheet, and a printing method may be a screen printing method or a gravure printing method, but the present disclosure is not limited thereto.

An average thickness of the first and second electrode patterns 11 and 22 is not particularly limited.

In the case of miniaturization and high capacity of the multilayer electronic component 100, the average thickness of the first and second electrode patterns 11 and 22 may be 0.35 μm or less, and in the case of improving reliability of the multilayer electronic component 100 under high temperature and high voltage, the average thickness of the first and second electrode patterns 11 and 22 may be 1 μm or more.

The average thickness of the first and second electrode patterns 11 and 22 may refer to an average thickness of one or more of the first and second electrode patterns 11 and 22, among the plurality of first and second electrode patterns 11 and 22.

For example, the average thickness of the first and second electrode patterns 11 and 22 may be a value obtained by averaging the thicknesses measured at ¼, 2/4, and ¾ points in which the electrode pattern is divided into four parts in a length direction, based on one layer of the electrode pattern adjacent to a point at which a longitudinal center line and a thickness direction center line of the body meet, in an electrode pattern extracted from an image obtained by scanning first and second direction cross-sections cut from a central portion of the body 110 in the third direction by a scanning electron microscope (SEM). When the measurement is expanded to upper two and lower two electrode patterns having equal intervals based on one layer of the electrode pattern adjacent to the point at which the longitudinal center line and the thickness direction center line of the body, an average thickness of the electrode pattern may be further generalized.

Referring to FIG. 6, the floating electrode layer 122 may include a floating electrode pattern 21 spaced apart from the third to sixth surfaces 3, 4, 5 and 6. The floating electrode pattern 21 may not be connected to external electrodes 130 and 140 described below.

A capacitance may be formed in a region overlapping the first electrode pattern 11 and the second electrode pattern 12 in the first direction. Specifically, a portion of the first electrode pattern 11 and a portion of the floating electrode pattern 21 may overlap each other in the first direction, and a portion of the second electrode pattern 12 and a portion of the floating electrode pattern 21 may overlap each other in the first direction.

In a conventional multilayer electronic component having a structure including divided electrode patterns and floating electrode patterns, a problem of increased heat generation due to the effect of equivalent series resistance (ESR) may occur, and a problem of not being able to effectively dissipate the generated heat may occur as a ratio of electrodes drawn out of a device decreases.

Accordingly, in a multilayer electronic component 100 according to an example embodiment of the present disclosure, the internal electrode layer 121 may include a first heat dissipation pattern 13, and the floating electrode layer 122 may include second heat dissipation pattern 21 and 22, so that the heat generated by the multilayer electronic component 100 may be effectively dissipated.

Meanwhile, in a multilayer electronic component having a structure including divided electrode patterns and floating electrode patterns, no electrode pattern exists between the divided electrode patterns, while there is no electrode pattern in a region corresponding to a separation region between the electrode patterns of the floating electrode pattern, resulting in warpage of the floating electrode pattern in a stacking and sintering process.

Accordingly, in the multilayer electronic component 100 according to an example embodiment of the present disclosure, the first heat dissipation pattern 13 may be disposed between the first electrode pattern 11 and the second electrode pattern 12, thereby compensating for a difference in a degree of stacking of the electrode patterns in regions corresponding to a separation region between the electrode patterns and a separation region between the electrode patterns of the floating electrode pattern, thereby preventing or alleviating warpage of the floating electrode pattern.

Referring to FIGS. 5 and 6, the first heat dissipation pattern 13 according to an example embodiment may be in contact with the fifth surface 5 and the sixth surface 6, and the second heat dissipation patterns 22 and 23 may be in contact with the fifth surface 5 and the sixth surface 6. Accordingly, the first heat dissipation pattern 13 may be exposed to the outside of the body 110 through the fifth surface 5 and the sixth surface 6, and the second heat dissipation patterns 22 and 23 may be exposed to the outside of the body 110 through the fifth surface 5 and the sixth surface 6, and the effect of dissipating heat generated inside the multilayer electronic part 100 to the outside may be further improved.

In an example embodiment, the first heat dissipation pattern 13 and the second heat dissipation patterns 22 and 23 may not be connected to the first external electrode 130 and the second external electrode 140. Accordingly, even when external moisture penetrates along the first heat dissipation pattern 13 and the second heat dissipation patterns 22 and 23, the problem of lowering the moisture resistance reliability of the multilayer electronic component 100 may be prevented or alleviated, and the phenomenon of a short circuit occurring between the first and second external electrodes 130 and 140 may be alleviated.

In an example embodiment, a minimum value of the distance in which the first heat dissipation pattern 13 and the second heat dissipation patterns 22 and 23 are spaced apart from the first external electrode 130 and the second external electrode 140 may be 100 μm or more, and thus, the phenomenon of a short circuit occurring between the first and second external electrodes 130 and 140 may be prevented. Meanwhile, an upper limit of the minimum value of the distance in which the first heat dissipation pattern 13 and the second heat dissipation patterns 22 and 23 are spaced apart from the first external electrode 130 and the second external electrode 140 is not particularly limited, and may be appropriately adjusted according to the size of the multilayer electronic component 100.

Referring to FIG. 5, in an example embodiment, the first heat dissipation pattern 13 may include a body portion 13a disposed in a space in which the first electrode pattern 11 and the second electrode pattern 12 are spaced apart from each other in the second direction, and lead portions 13b and 13c extending from the body portion 13a in the third direction to come into contact with the fifth surface 5 and the sixth surface 6.

The body portion 13a may be disposed in the space in which the first electrode pattern 11 and the second electrode pattern 12 are spaced apart from each other in the second direction, thus serving to compensate for a difference in the degree of stacking of the electrode patterns of the internal electrode layer 121 and the floating electrode layer 122, and the lead portions 13b and 13c may be in contact with the fifth surface 5 and the sixth surface 6 of the body 110, thus effectively dissipating the heat generated inside the multilayer electronic component 100.

In order to further improve the heat dissipation effect, it may be necessary to improve an area or a length of the lead portions 13b and 13c in contact with a surface of the body 110. Accordingly, in an example embodiment, an average length of the lead portions 13b and 13c in the second direction may be formed to be longer than an average length of the body portion 13a in the second direction, so that it may be possible to secure the effect of preventing the warpage of the floating electrode pattern 21 while improving the heat release efficiency of the multilayer electronic component 100.

A method of measuring an average length of the lead portions 13b and 13c in the second direction is not particularly limited, and an average value of lengths of the lead portions disposed in two layers with equal intervals in an upper portion and two layers with equal intervals in a lower portion may be measured based on the lead portion disposed in a central portion of the first direction, among the lead portions 13b and 13c exposed to the surface of the body 110.

In an example embodiment, when an average value of a distance between the first electrode pattern 11 and the second electrode pattern 12 in the second direction is defined as A1, and an average length of the second direction of the body portion 13a is defined as A2, A2/A1 may satisfy 0.22 or more and 0.78 or less. When A2/A1 is less than 0.22, the effect of preventing the warpage of the floating electrode pattern may be insufficient to cause cracks in the multilayer electronic component 100, and when A2/A1 exceeds 0.78, spreading may occur between the first and second electrode patterns 11 and 12 and the first heat dissipation pattern 13.

In an example embodiment, when an average value of a distance in which the first and second electrode patterns 11 and 12 are spaced apart from the fifth surface 5 and the sixth surface 6 in the third direction is defined as B1, and an average value of a distance in which the lead portions 13b and 13c are spaced apart from the first and second electrode patterns 11 and 12 in the third direction is defined as B2, B2/B1 may satisfy 0.22 or more and 0.78 or less. When B2/B1 is less than 0.22 or B2/B1 exceeds 0.78, the effect of dissipating heat generated inside the multilayer electronic component 100 may be somewhat insufficient, and spreading may occur between the first and second electrode patterns 11 and 12 and the first heat dissipation pattern 13.

A method of measuring A1, which is the average value of the distance in which the first electrode pattern 11 and the second electrode pattern 12 are spaced apart from each other in the second direction, and A2, which is the average length of the body portion 13a in the second direction, is not particularly limited, but in an image obtained by scanning a cross-section as in FIG. 2, which is a cross-section of the first and second directions polished to the center of the multilayer electronic component 100 in the third direction, by a scanning electron microscope (SEM) or an optical microscope (OM), or the like, A1 and A2 may be measured by averaging the values measured from the upper two and lower two internal electrode layers 121 having equal intervals based on the internal electrode layer 121 disposed in the first direction center.

A method of measuring B1, which is the average value of the distance in which the first and second electrode patterns 11 and 12 are spaced apart from the fifth surface 5 and the sixth surface 6 in the third direction, and B2, which is the average value of the distance in which the lead portions 13b and 13c are spaced apart from the first and second electrode patterns 11 and 12 in the third direction, is not particularly limited, but in an image obtained by scanning a cross-section as in FIG. 4, which is a cross-section of the first and third directions polished to the second direction ⅓ point of the multilayer electronic component 100, by a scanning electron microscope (SEM) or an optical microscope (OM), or the like, B1 and B2 may be measured by averaging the values measured from the upper two and lower two internal electrode layers 121 having equal intervals based on the internal electrode layer 121 disposed in the first direction center.

In an example embodiment, the first heat dissipation pattern 13 and the second heat dissipation patterns 22 and 23 may include an oxide including a conductive metal. Specifically, the first heat dissipation pattern 13 and the second heat dissipation patterns 22 and 23 may include at least one of a conductive metal or an oxide of a conductive metal.

The more conductive metals included in the first heat dissipation pattern 13 and the second heat dissipation patterns 22 and 23, the more advantageous this may be for improving heat dissipation characteristics, and the more oxides of the conductive metal included in the first heat dissipation pattern 13 and the second heat dissipation patterns 22 and 23, the more advantageous this may be for improving bonding strength with the dielectric layer 111.

The conductive metal included in the first heat dissipation pattern 13 and the second heat dissipation patterns 22 and 23 is not particularly limited, but may include one or more of nickel (Ni), silver (Ag), aluminum (Al), and copper (Cu) having excellent thermal conductivity.

In an example embodiment, a ratio of a content of oxygen to a content of the conductive metal included in the first and second heat dissipation patterns 13, 22 and 23 may be 0.5 at % or more and 10 at % or less. Accordingly, the effect of improving the heat dissipation characteristics of the multilayer electronic component 100 and the effect of securing interlayer bonding force between the dielectric layer 111 and the first and second heat dissipation patterns 13, 22 and 23 may be secured at the same time.

Referring to FIGS. 2 to 4, the body 110 may include cover portions 112 and 113 disposed on an internal electrode layer 121 disposed on an outermost layer and a floating electrode layer 122 disposed on an outermost layer.

The cover portions 112 and 113 may be formed by stacking a single dielectric layer or two or more dielectric layers on upper and lower surfaces of the internal electrode layer 121 disposed on an outermost layer and the floating electrode layer 122 disposed on an outermost layer in the first direction, respectively, and may basically play a role in preventing damage to the internal electrode due to physical or chemical stress.

The cover portions 112 and 113 does not include electrode patterns 11, 12 and 13 and may include the same dielectric material as the dielectric layer 111. That is, the cover portions 112 and 113 may include a ceramic material, for example, a barium titanate (BaTiO₃)-based ceramic material.

Meanwhile, the thickness of the cover portions 112 and 113 does not need to be particularly limited. For example, an average thickness of the cover portions 112 and 113 may be 10 to 300 μm. The average thickness of the cover portions 112 and 113 may refer a size in the first direction, and may be an average value of first direction sizes of the cover portions 112 and 113 measured at five points spaced apart from each other by equal intervals in the third direction.

The external electrodes 130 and 140 may be disposed on the third surface 3 and the fourth surface 4 of the body 110.

The external electrodes 130 and 140 may be disposed on the third and fourth surfaces 3 and 4 of the body 110, respectively, and may include the first and second external electrodes 130 and 140 connected to the first and second electrode patterns 11 and 12, respectively. Specifically, the first external electrode 130 may be disposed on the third surface 3 and connected to the first electrode pattern 11, and the second external electrode 140 may be disposed on the fourth surface 4 and connected to the second electrode pattern 12.

In an example embodiment, the structure of the multilayer electronic component 100 having two external electrodes 130 and 140 is described, but the number or shape of the external electrodes 130 and 140 may be changed depending on the shape of the internal electrode layer 121 or other purposes.

Meanwhile, the external electrodes 130 and 140 may be formed using any material having electrical conductivity, such as metal, and a specific material may be determined in consideration of electrical characteristics, structural stability, and the like, and may further have a multilayer structure.

For example, the external electrodes 130 and 140 may include electrode layers 131 and 141 disposed on the body 110 and plating layers 132 and 142 formed on the electrode layer.

For a more specific example of the electrode layers 131 and 141, the electrode layers 131 and 141 may be a sintering electrode including a conductive metal and glass, or a resin-based electrode including a conductive metal and resin.

Additionally, the electrode layers 131 and 141 may be in the form in which the sintering electrode and the resin-based electrode are sequentially formed on the body. Additionally, the electrode layer may be formed by transferring a sheet including a conductive metal onto the body, or may be formed by transferring a sheet including a conductive metal onto the sintering electrode. Additionally, the electrode layer may be formed as a plating layer, or may be a layer formed using a deposition method such as a sputtering method or an atomic layer deposition (ALD).

The conductive metal included in the electrode layers 131 and 141 may be a material having excellent electrical conductivity, and is not particularly limited. For example, the conductive metal may be at least one of nickel (Ni), copper (Cu) or alloys thereof.

The plating layers 132 and 142 may serve to improve the mounting characteristics. The type of the plating layer is not particularly limited, and may be a plating layer including at least one of Ni, Sn, Pd or alloys thereof, and may be formed of a plurality of layers.

For more specific examples of the plating layers 132 and 142, the plating layer may be a Ni plating layer or an Sn plating layer, and may be in a form in which the Ni plating layer and the Sn plating layer are sequentially formed on the electrode layer, or in a form in which the Sn plating layer, the Ni plating layer and the Sn plating layer are sequentially formed. Additionally, the plating layer may include a plurality of Ni plating layers and/or a plurality of Sn plating layers. Additionally, the plating layer may be in a form in which the Ni plating layer and the Pd plating layer are sequentially formed on the electrode layer.

The size of the multilayer electronic component 100 does not need to be specifically limited. According to the present disclosure, since the size thereof is advantageous for miniaturization and high capacity, this may be applied to the size of small IT products, and since the multilayer electronic component 100 may secure high reliability in various environments, this may be applied to a size of electric field products requiring high reliability.

### Inventive Example

Table 1 illustrates the results of a crack defect inspection conducted on samples of multilayer electronic components obtained by adjusting a ratio of an average value A1 of a distance in which the first electrode pattern 11 and the second electrode pattern 12 are spaced apart from each other in the second direction to an average length A2 of the body portion 13a in the second direction.

All samples for each test number included an internal electrode layer 121 and a floating electrode layer 122 according to an example embodiment of the present disclosure, and the average value A1 of the distance in which the first electrode pattern 11 and the second electrode pattern 12 are spaced apart from each other in the second direction were fixed to 0.46 μm and the ratio of the average length A2 of the body portion 13a in the second direction was varied.

The crack defect inspection was conducted on 30 samples for each test number using C-Mode Scanning Acoustic Microscopy (C-SAM), and when occurrence of cracks in the central portion of the body exceeds 10%, this was evaluated as NG, and when the occurrence of the cracks satisfied 10% or less, this was evaluated as OK.

TABLE 1

| Test | | | | Crack Defect |
|---|---|---|---|---|
| Number | A1(μm) | A2(μm) | A2/A1 | Inspection |
| 1 | 0.46 | 0.05 | 0.11 | NG |
| 2 | 0.46 | 0.10 | 0.22 | OK |
| 3 | 0.46 | 0.15 | 0.33 | OK |
| 4 | 0.46 | 0.36 | 0.78 | OK |

Referring to Table 1, it may be known that in the case of test number 1 in which A2/A2 is less than 0.22, this corresponds to NG in the crack defect inspection, and it may be known that in the case of test numbers 2 to 4 in which A2/A1 is 0.22 or more, this corresponds to OK in the crack defect inspection. That is, as in an example embodiment, in the case in which A2/A1 is 0.22 or more, the effect of preventing warpage of the floating electrode pattern is sufficient, and thus, it may be confirmed that the effect of preventing crack occurrence in the multilayer electronic component 100 is excellent.

Although an example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the technical concept of the present disclosure defined by the appended claims, and these replacements, modifications, or changes should be construed as being included in the technical concept of the present disclosure.

Additionally, the expression ‘an example embodiment’ used in the present disclosure does not mean the same embodiment, and is provided to emphasize and explain different unique characteristics. However, the example embodiments presented above do not preclude being implemented in combination with the features of another embodiment. For example, although items described in a specific example embodiment are not described in another example embodiment, the items may be understood as a description related to another example embodiment unless a description opposite or contradictory to the items is in another example embodiment.

In the present disclosure, the terms are merely used to describe a specific example embodiment, and are not intended to limit the present disclosure. Singular forms may include plural forms as well unless the context clearly indicates otherwise.

What is claimed is:

1. A multilayer electronic component, comprising:
a body including:
a dielectric layer;
an internal electrode layer and a floating electrode layer alternately disposed in a first direction with the dielectric layer interposed therebetween;
a first surface and a second surface opposing each other in the first direction;
a third surface and a fourth surface opposing each other in a second direction, perpendicular to the first direction; and
a fifth surface and a sixth surface opposing each other in a third direction, perpendicular to the first direction and the second direction;
a first external electrode disposed on the third surface; and
a second external electrode disposed on the fourth surface,
wherein the internal electrode layer includes a first electrode pattern connected to the first external electrode at the third surface, a second electrode pattern connected to the second external electrode on the fourth surface and spaced apart from the first electrode pattern in a second direction, and a first heat dissipation pattern disposed between the first electrode pattern and the second electrode pattern, and
wherein the floating electrode layer includes a floating electrode pattern spaced apart from the third surface to the sixth surface and a second heat dissipation pattern spaced apart from the floating electrode pattern in the third direction.

2. The multilayer electronic component according to claim 1, wherein the first heat dissipation pattern is in contact with the fifth surface and the sixth surface, and the second heat dissipation pattern is in contact with the fifth surface and the sixth surface.

3. The multilayer electronic component according to claim 1, wherein the first heat dissipation pattern is exposed to an outside of the body through the fifth surface and the sixth surface, and the second heat dissipation pattern is exposed to the outside of the body through the fifth surface and the sixth surface.

4. The multilayer electronic component according to claim 2, wherein the first heat dissipation pattern and the second heat dissipation pattern are spaced apart from the first external electrode and the second external electrode.

5. The multilayer electronic component according to claim 4, wherein a minimum value of a separation distance between the first heat dissipation pattern and the second heat dissipation pattern and the first external electrode and the second external electrode in the second direction is 100 μm or more.

6. The multilayer electronic component according to claim 1, wherein the first heat dissipation pattern includes a body portion disposed in a space in which the first electrode pattern and the second electrode pattern are spaced apart from each other in the second direction, and a lead portion extending from the body portion in the third direction to come into contact with the fifth surface and the sixth surface.

7. The multilayer electronic component according to claim 6, wherein an average value of a distance in which the first electrode pattern and the second electrode pattern are spaced apart from each other in the second direction is defined as A1, and an average length of the body portion in the second direction is defined as A2, and
Wherein A2/A1 satisfies 0.22 or more and 0.78 or less.

8. The multilayer electronic component according to claim 6, wherein an average value of a distance in which the first and second electrode patterns are spaced apart from the fifth and sixth surfaces in the third direction is defined as B1, and an average value of a distance in which the lead portion is spaced apart from the first and second electrode patterns in the third direction is defined as B2, and
wherein B2/B1 satisfies 0.22 or more and 0.78 or less.

9. The multilayer electronic component according to claim 6, wherein an average length of the lead portion in the second direction is longer than an average length of the body portion in the second direction.

10. The multilayer electronic component according to claim 1, wherein the first heat dissipation pattern and the second heat dissipation pattern include an oxide including a conductive metal.

11. The multilayer electronic component according to claim 10, wherein the conductive metal includes at least one of nickel (Ni), silver (Ag), aluminum (Al) or copper (Cu).

12. The multilayer electronic component according to claim 11, wherein a ratio of a first content of oxygen to a second content of the conductive metal included in the first heat dissipation pattern and the second heat dissipation pattern is 0.5 at % or more and 10 at % or less.
